(19) United States
(12) Patent Application Publication
(10) Pub. No.: US 2021/0165963 A1
(43) Pub. Date: Jun. 3, 2021

(54) AUTOMATIC CLASSIFICATION OF DRILLING REPORTS WITH DEEP NATURAL LANGUAGE PROCESSING

(71) Applicant: LANDMARK GRAPHICS CORPORATION, Houston, TX (US)

(72) Inventors: Julio Hoffimann MENDES, Stanford, CA (US); Youli MAO, Houston, TX (US); Aimee TAYLOR, Bogota (CO); Avinash WESLEY, New Caney, TX (US)

(73) Assignee: LANDMARK GRAPHICS CORPORATION, Houston, TX (US)

(21) Appl. No.: 16/061,630

(22) PCT Filed: Dec. 14, 2016
(86) PCT No.: PCT/US2016/066621

§ 371 Date: Jun. 12, 2018

(51) Int. Cl. G06F 40/289; G06F 40/40; G06F 40/30; G06N 3/04; G06N 3/08; G01V 11/00

(52) U.S. Cl. CPC G06F 40/289; G06F 40/40; G06F 40/30; E21B 41/00; G06N 3/08; G01V 11/002; G06N 3/04

(57) ABSTRACT

Systems, methods, and computer-readable media for automatic classification of drilling reports with deep natural language processing. A method may involve obtaining drilling reports associated with respective well drilling or operation activities, and based on the drilling reports, generating a plurality of word vectors, wherein each word vector from the plurality of word vectors represents a respective word in the drilling reports. The method can further involve partitioning sentences in the drilling reports into respective words and, for each sentence, identifying respective word vectors from the plurality of word vectors, the respective word vectors corresponding to the respective words associated with the sentence. The method can involve classifying via a neural network, the sentences in a drilling report into at least one of respective events, respective symptoms, respective actions, and respective results. The method can also classify sentences according to any set of labels of interest.

### TECHNICAL FIELD

The present technology pertains to analyzing drilling reports, and more specifically to automatic classification of drilling reports with deep natural language processing.

### BACKGROUND

Drilling activities in oil and gas are a shared concern among energy companies, government agencies, and the general public, as they can impact both the profits of the various parties and the natural environment. Accordingly, it is important to obtain accurate and thorough data related to drilling activities, which can be used to study the drilling activities in order to learn from previous drilling activities and optimize future drilling activities. To this end, oil and gas companies often generate drilling reports for respective drilling activities.

Drilling reports contain rich information such as well state information, including symptoms and events reported in situ by the drillers in free-form text. This information can provide new insights into the drilling process and support future drilling strategies. However, the size and volume of drilling reports generated by oil and gas companies renders any meaningful analysis of these reports unfeasible. Furthermore, the complexity and free-form nature of drilling reports makes the task of analyzing these types of reports even more challenging.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates a diagrammatic view of a logging while drilling (LWD) wellbore operating environment;

FIG. 1B illustrates a schematic diagram of an example system for downhole line detection in a downhole environment having tubulars;

FIG. 2 illustrates example drilling reports;

FIG. 3 illustrates example workflows for classification of drilling reports;

FIG. 4A illustrates an example word cloud generated from drilling reports;

FIG. 4B illustrates an example interactive word cloud generated from drilling reports;

FIG. 5 illustrates an example dendrogram of concepts from drilling reports;

FIGS. 6A through 6D illustrate example neural networks for classifying sentences in drilling reports;

FIG. 7 illustrates an example word cloud generated from drilling reports;

FIG. 8 illustrates an example plot of sentence lengths from drilling reports;

FIG. 9 illustrates a chart depicting a frequency of 3-grams in example drilling reports;

FIG. 10 illustrates an example classification of sentences from drilling reports;

FIG. 11A illustrates an example search and recommendation tool for searching and presenting concepts and sequences in drilling reports;

FIG. 11B illustrates an example search and recommendation tool that gives success rates for actions taken in the past for a symptom observed in real time;

FIG. 12A illustrates a diagram of an example NPT sequencing in reports from different operators for different wells;

FIG. 12B illustrates a chart illustrating selective extraction of wells based on automated classification;

FIG. 12C illustrates a classification of drilling reports presented in a Geographic Information System (GIS);

FIG. 13 illustrates an example method embodiment;

FIG. 14 illustrates schematic diagram of example computing device.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

### Overview

Disclosed are systems, methods, and computer-readable storage media for automatic classification and presentation of drilling reports using deep natural language processing. In some examples, a system can obtain drilling reports associated with respective well drilling or operation activities. Further, the system can generate, based on the drilling reports, word vectors, where each word vector represents a respective word in the drilling reports. The system can also partition sentences in the drilling reports into respective words and, for each sentence, identify respective word vectors corresponding to the respective words associated with the sentence.

Based on the respective word vectors, the system can classify the sentences into respective events, respective symptoms, respective actions, respective results, and so forth. The system can classify the sentences using a neural network into concepts, categories, etc. For example, the system can classify sentences into symptom, action, result, event, etc. The system can generate a tool that allows users to search sentences or drilling reports based on classifications and/or sequences of classifications.

To illustrate, the system can generate a tool that allows a user to search for symptoms matching search string X, and limit the search to the sequence symptom→action→result, where the symptom is based on the search string as previously explained. The system can also generate visually interactive tools which can depict concepts or classifications in a screen based on a predetermined pattern or configuration, such as a word cloud or a graph, for example. This can allow the user to view select one or more drilling reports or clusters of reports based on a specific concept or classification. Moreover, the system can present the classification of drilling reports in a Geographic Information System (GIS) that would help sales teams identify what regions in a map need their products based on the types of problems and symptoms that occur, for example. These example tools can be used by users in real-time to troubleshoot problems during drilling activities or manage the process and progress of the drilling activities.

### Description

As previously explained, drilling reports contain valuable intelligence on well state and operations. Unfortunately, previously, the drilling reports and intelligence contained in the reports are significantly underutilized and unexploited. This is largely due to the size and volume of drilling reports generated by oil and gas companies renders any meaningful analysis of these reports unfeasible, and the complexity and free-form nature of drilling reports has restricts or limits intelligent, automated, or computerized analysis of these types of reports.

The disclosed technology addresses the need in the art for tools capable of performing intelligent, automated, and effective analysis, classification, and presentation of drilling reports and intelligence. The approaches herein can provide accurate and computerized tools for automatic classification of drilling reports. Such tools can be robust and capable of correcting or understanding typing errors, abbreviations, language shortcuts or terms of art, symbols, acronyms, etc. The technologies and approaches herein can provide interactive visualizations of the hidden semantic relationships of concepts between drilling reports, and graphical tools for retrieving or filtering data based on report sequencing and classifications. The graphical tools and visualizations can allow users and engineers to quickly identify and sift through relevant sequences within large volumes of drilling reports, and efficiently interact and understand concepts and intelligence provided in the drilling reports.

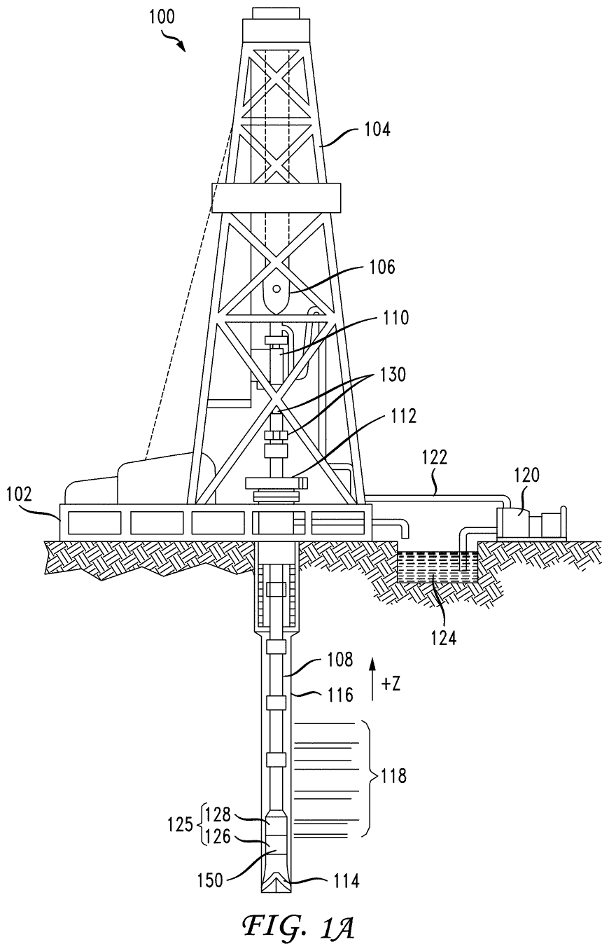

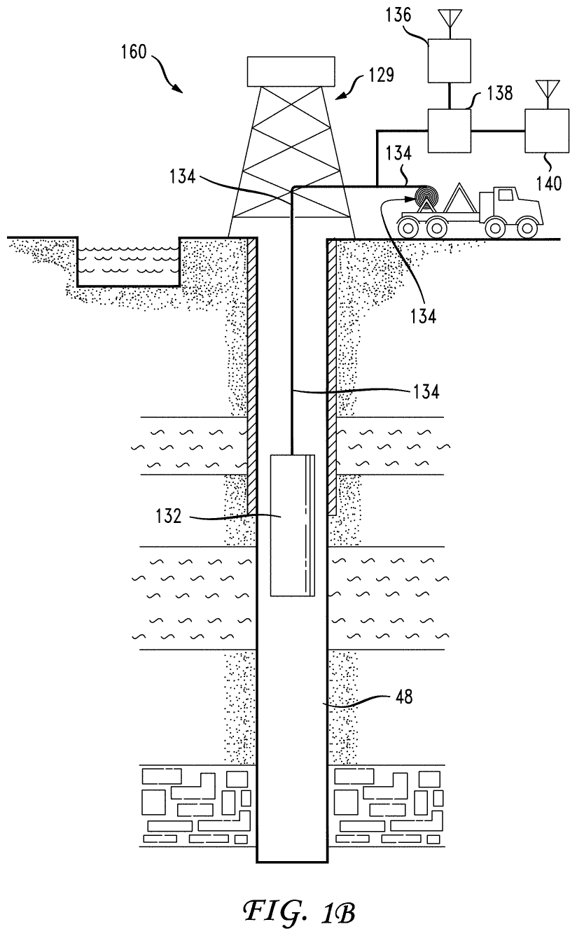

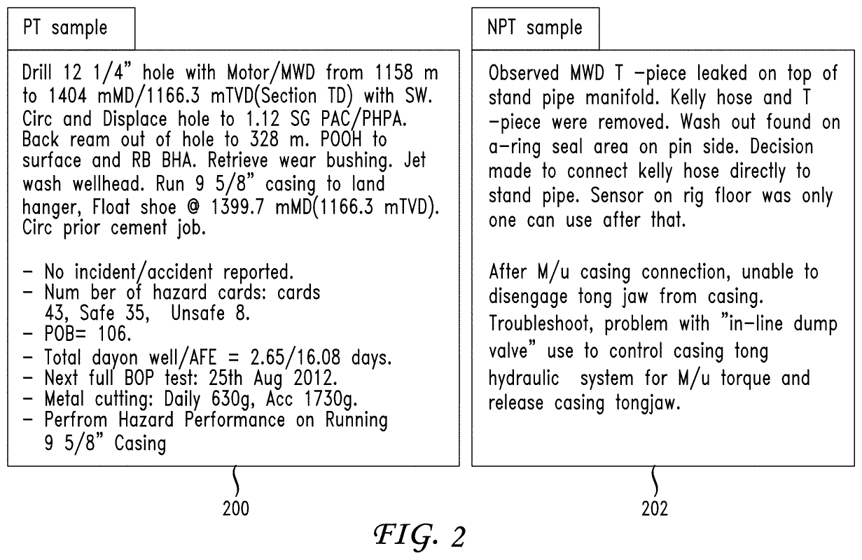

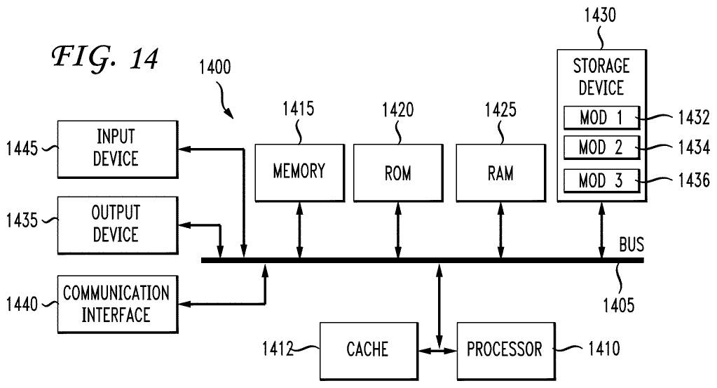

Disclosed are systems, methods, and computer-readable storage media for automatic classification and presentation of drilling reports using deep natural language processing. A brief introductory description of exemplary systems and environments, as illustrated in FIGS. 1A and 1B, is first disclosed herein. A detailed description of various methods, systems, and concepts for automatic classification and presentation of drilling reports, as shown in FIGS. 2-13, will then follow. The disclosure will conclude with a description of example computing devices, as shown in FIG. 14, which can be implemented for various operations and functions disclosed herein. These variations shall be described herein as the various embodiments are set forth. The disclosure now turns to FIG. 1A.

FIG. 1A illustrates a diagrammatic view of a logging while drilling (LWD) wellbore operating environment 100 in which the presently disclosed apparatus, method, and system, may be deployed in accordance with certain exemplary embodiments of the present disclosure. As depicted in FIG. 1A, a drilling platform 102 is equipped with a derrick 104 that supports a hoist 106 for raising and lowering a drill string 108. The hoist 106 suspends a top drive 110 suitable for rotating the drill string 108 and lowering the drill string 108 through the well head 112. Connected to the lower end of the drill string 108 is a drill bit 114. As the drill bit 114 rotates, the drill bit 114 creates a wellbore 116 that passes through various formations 118. A pump 120 circulates drilling fluid through a supply pipe 122 to top drive 110, down through the interior of drill string 108, through orifices in drill bit 114, back to the surface via the annulus around drill string 108, and into a retention pit 124. The drilling fluid transports cuttings from the wellbore 116 into the pit 124 and aids in maintaining the integrity of the wellbore 116. Various materials can be used for drilling fluid, including oil-based fluids and water-based fluids.

Logging tools 126 can be integrated into the bottom-hole assembly 125 near the drill bit 114. As the drill bit 114 extends the wellbore 116 through the formations 118, logging tools 126 collect measurements relating to various formation properties as well as the orientation of the tool and various other drilling conditions. The bottom-hole assembly 125 may also include a telemetry sub 128 to transfer measurement data to a surface receiver 130 and to receive commands from the surface. In at least some cases, the telemetry sub 128 communicates with a surface receiver 130 using mud pulse telemetry. In some instances, the telemetry sub 128 does not communicate with the surface, but rather stores logging data for later retrieval at the surface when the logging assembly is recovered.

Each of the logging tools 126 may include a plurality of tool components, spaced apart from each other, and communicatively coupled with one or more wires. The logging tools 126 may also include one or more computing devices 150 communicatively coupled with one or more of the plurality of tool components by one or more wires. The computing device 150 may be configured to control or monitor the performance of the tool, process logging data, and/or carry out the methods of the present disclosure.

In at least some instances, one or more of the logging tools 126 may communicate with a surface receiver 130 by a wire, such as wired drillpipe. In other cases, the one or more of the logging tools 126 may communicate with a surface receiver 130 by wireless signal transmission. In at least some cases, one or more of the logging tools 126 may receive electrical power from a wire that extends to the surface, including wires extending through a wired drillpipe.

Referring to FIG. 1B, a tool having tool body 132 can be employed with “wireline” systems, in order to carry out logging or other operations. For example, instead of using the drill string 108 of FIG. 1A to lower tool body 132, which may contain sensors or other instrumentation for detecting and logging nearby characteristics and conditions of the wellbore and surrounding formation, a wireline conveyance 134 can be used. For example the tool body 132 may include resistivity logging tool. The tool body 132 can be lowered into the wellbore 48 by wireline conveyance 134. The wireline conveyance 134 can be anchored in the drill rig 129 or portable means such as a truck. The wireline conveyance 134 can include one or more wires, slicklines, cables, or the like, as well as tubular conveyances such as coiled tubing, joint tubing, or other tubulars.

The illustrated wireline conveyance 134 provides support for the tool, as well as enabling communication between the tool processors on the surface and providing a power supply. The wireline conveyance 134 can include fiber optic cabling for carrying out communications. The wireline conveyance 134 is sufficiently strong and flexible to tether the tool body 132 through the wellbore 48, while also permitting communication through the wireline conveyance 134 to local processor 138 and/or remote processors 136, 140. Additionally, power can be supplied via the wireline conveyance 134 to meet power requirements of the tool. For slickline or coiled tubing configurations, power can be supplied downhole with a battery or via a downhole generator.

Having disclosed example drilling environments and tools, the disclosure now turns to a discussion of classification and presentation of drilling reports and related concepts.

Operators and/or drillers can generate drilling reports for specific well operations, such as drilling operations and activities. As previously indicated, drilling reports can contain rich information and statistics about well state and well operations such as drilling activities. Indeed, drilling reports can contain a large amount of intelligence, data, statistics, etc., which can provide valuable insight into well state and operations. Non-limiting examples of data which can be contained in drilling reports include events, actions, symptoms, results, logging details, etc. Some or all of the information in drilling reports can be reported in situ by drillers and/or operators. Drilling reports can also include various types and/or formats of data, such as free-form text, symbols, formulas, acronyms, expressions, terms of art, etc.

FIG. 2 illustrates example drilling reports 200, 202. Drilling report 200 can contain information captured during productive time period(s) and/or regarding productive time period(s). Drilling report 202 can include information captured during non-productive time period(s) and/or regarding non-productive time period(s). Productive time (PT) periods can refer to periods when drilling operations are being performed in a drilling session or project. On the other hand, non-productive time (NPT) periods can refer to periods during a drilling session or project when actions are being taken to solve an issue, accident, error, problem, etc.

For example, drilling tools can sometimes get stuck due to miscalculations or limited knowledge about the ground or surface. In this example, the NPT can include the time spent fishing or rescuing the tool and/or performing any adjustments before drilling resumes.

The reports 200, 202 can include a log of events during the PT and NPT, respectively, as well as other related information such as observations, analysis, notes, etc. The reports 200 and/or 202 can then be analyzed, classified, processed, etc., as further described below.

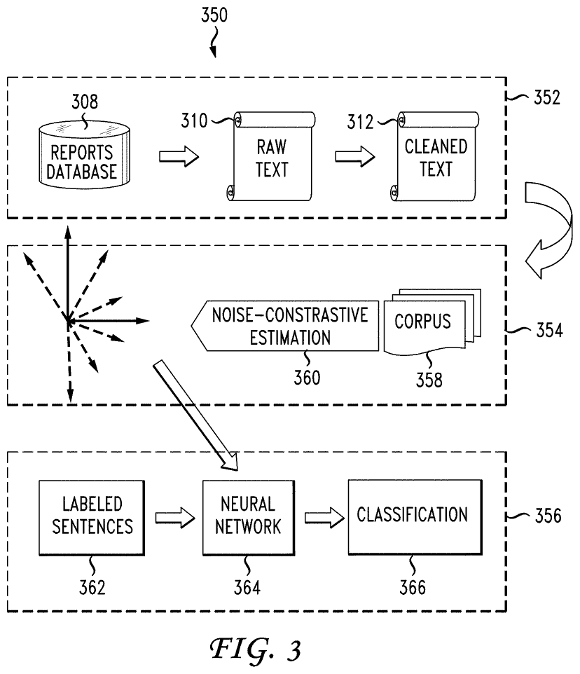

FIG. 3 illustrates an example workflow 350 for classification of drilling reports 200 and/or 202. The workflow 350 can include three steps: Cleaning of drilling reports 352, Word-to-vector transformation 354 and Sentence classification 356. By the end of the word-to-vector transformation 354, interactive plots can be drawn to illustrate the concepts present in the drilling reports at multiple levels of detail. These vectors learned in the word-to-vector transformation 354 are then used for sentence classification in 356.

The text extraction and cleaning process 352 can include extracting text from a database 308 containing drilling reports to obtain a corpus 310 of text from the drilling reports. When generating the corpus, the text can be concatenated into one or more files. The corpus 310 can then be cleaned to yield cleaned text 312. The cleaning of text can involve removing certain symbols (e.g., &, #, −, etc.), replacing acronyms with their corresponding short descriptions or full names (e.g., POOH replaced with pull out of hole, etc.). In some cases, symbols and/or short-text can be replaced with regular expressions. Below is a table of regular expression substitutions.

TABLE 1
Regular Expression Substitutions (PHYTHON Syntax).

| FROM | TO | PURPOSE |
|---|---|---|
| ‘,\s’ | ‘’ | Commas at end of words |
| ‘, ([a-z A-Z])’ | ‘\1’ | Commas at end of words |
| ‘\((. * ?)\)’ | ‘\1’ | Enclosing parenthesis |
| ‘\x e\x 8 0\x a 2’ | ‘’ | Bullet marks |
| ‘-\s’ | ‘’ | Dashes |
| ‘==+ \|\*\* +’ | ‘’ | Horizontal bars |
| ‘\[(. * ?)\]’ | ‘\1’ | Enclosing brackets |
| ‘# \|;’ | ‘’ | Pounds and semicolons |
| ‘_’ | ‘’ | Underscores |
| ‘\s/\s’ | ‘’ | Orphan forward slashes |

Further lemmatization can be performed in the cleaning step. For example, plurals can be removed or converted to singular form (e.g., wells can be converted to well).

In the vectorization and plotting process 354, the cleaned text 312 can be split/divided/partitioned into words 358, and the resulting corpus can be passed to a word-to-vector transformation function 360. The word-to-vector transformation function 360 can perform one or more functions, algorithms, and/or operations to transform the words 358 into a set of vectors. In some cases, the set of vectors can be of high dimension, such as 300, for example.

The output of the word-to-vector transformation function (i.e., the set of vectors) can be projected in a plane to yield a projected plane. The plane can be, for example, a 2D Cartesian plane, a graph or scatter plot, etc. In some examples, the set of vectors can be projected into the plane by means of dimensionality reductions techniques, such as t-distributed stochastic neighbor embedding (t-SNE).

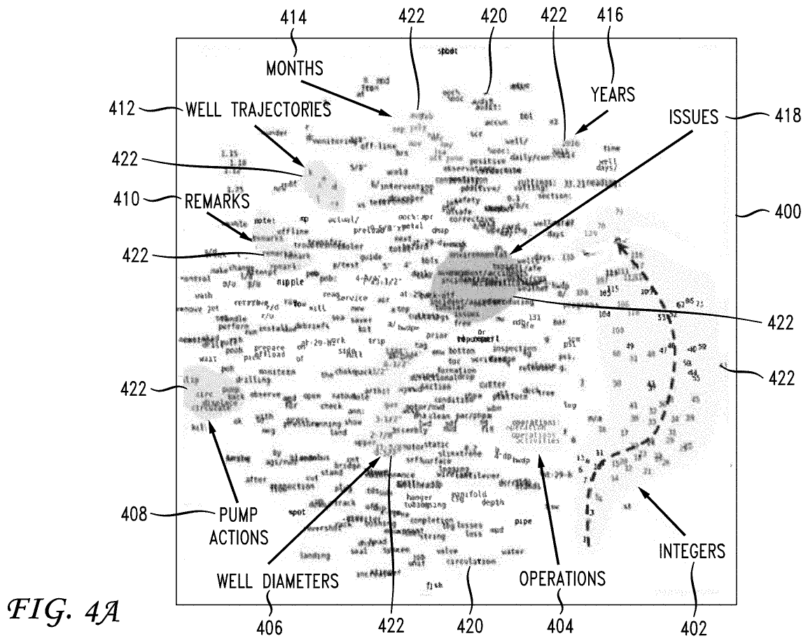

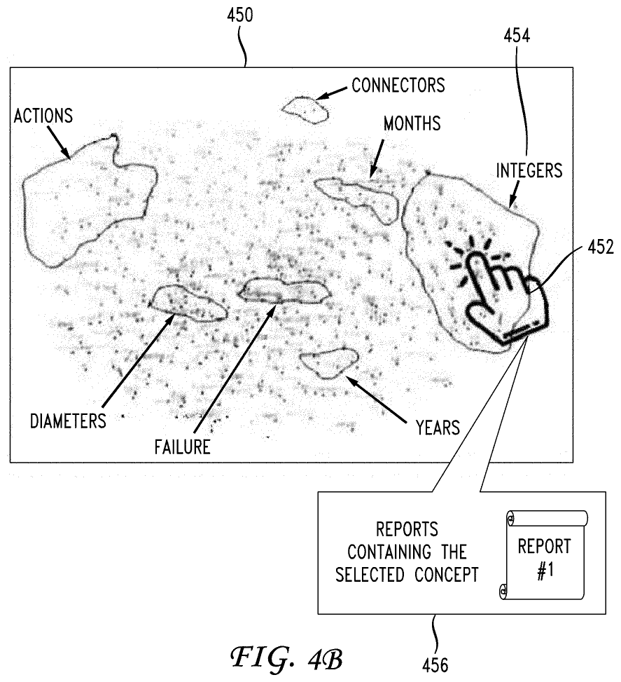

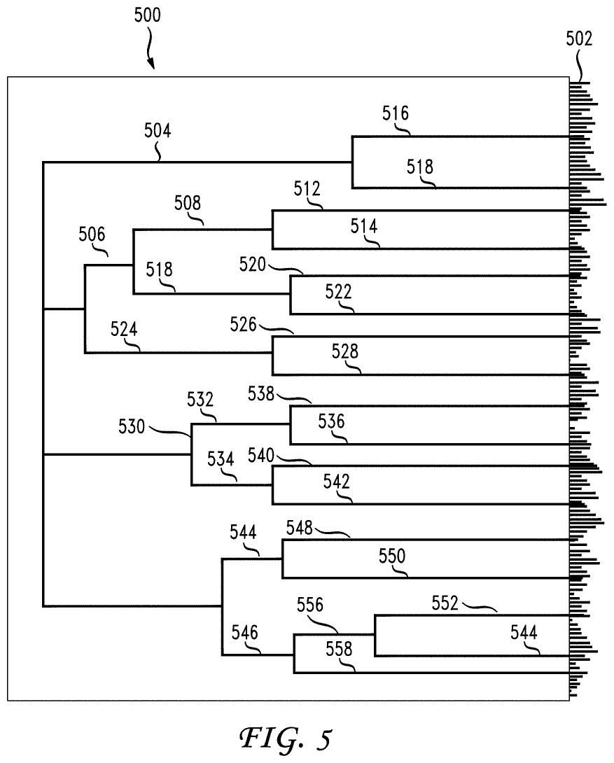

In the visualization process, the projected plane can be used to generate one or more visualizations. To illustrate, the projected plane can be used to generate a word cloud in FIG. 4A and FIG. 4B and/or a dendrogram in FIG. 5. In some cases, for each point in the plane and/or visualizations, a label can be added corresponding to the associated word of the particular point. Other visualization techniques can also be implemented to depict relationships (e.g., semantic relationships), associated concepts (e.g., integers, issues, well trajectories, years, operations, well diameters, pump actions, remarks, etc.), grouping or clustering, etc. For example, given the number of concepts specified by the user, words can be clustered into different colors, shapes, objects, containers, labels, etc. Non-limiting examples of visualizations are illustrated in FIGS. 4A-B and 5, and further described below with reference to FIGS. 4A-B and 5.

In the text extraction and cleaning process 352, drilling reports and/or operational notes can be extracted from database 308. In some cases, the text can be concatenated in chronological order, for example. The reports 310 extracted from the database 308 can then be cleaned to yield cleaned reports 312. The reports 310 can be cleaned as previously explained, by removing or replacing specific types of items, such as symbols, acronyms, etc. The cleaning operations can serve as a denoising layer.

In the word encoding and plotting process 354, a corpus 358 can be generated from the cleaned reports 312. A noise-constrastive estimation 360 or similar technique can be performed on the corpus 358, and words can be plotted and encoded.

Labeled sentences 362 can then be used to train a neural network 364 for performing classification of unseen sentences 366. The neural network 364 can vary. For example, the neural network 364 can be a simple network with arithmetic averaging, a convolutional neural network (CNN), a long short-term memory network (LSTM), etc. Moreover, the classification 366 can classify the sentences into categories or concepts, such as events, actions, symptoms, results, etc.

In one example, the neural network 364 can be a simple network with arithmetic averaging. In this example, fixed-length features can be assigned to sentences by averaging (i.e., reduction operation) their constituent word vectors. This feature can then be passed to a fully connected hidden layer with 20 tanh neurons followed by a softmax classification.

An example implementation of workflow 350 can be as follows. After the cleaning process, the total number of tokens and/or vocabulary size in the corpus can be reduced to T=810375 and V=17623, respectively, for example. To illustrate, the Mikolov et al. methodology, known in the art, can be implemented. The corpus can be scanned with a fixed window of size m=3, and each word wᵢ; i=1; 2; . . . ; V in the vocabulary can be assigned two random vectors uᵢ; vᵢϵ [−1; 1]^{d} with d=300 the embedding dimension. The word wᵢ can be in the center of a window, in which case vᵢ is the associated vector representation, or an outer (or target) word for which uᵢ is looked up likewise. Within a context window centered at a word w_{c}, a correct outer word wₒ can be sampled. Furthermore k=64 words w1; w2; . . . ; wk are sampled from the vocabulary at random from the unigram distribution P (w). The probability of the pair (w_{c}; wₒ) can be maximized and the probability of the pairs (w_{c}; wᵢ); i=1; 2; . . . ; k can be minimized with the objective:

Jₜ=log σ(u_{O}^{T}v_{c})+Σᵢ₌₁^{k} [symbol] wᵢP(w)[ log σ(−uᵢ^{T}v_{c})] Eq. 1

and

$$σ ( x ) = \frac{1}{1 + {e}^{- x}}$$

is the sigmoid function. This process can be repeated for all context windows throughout the corpus leading to the total objective J=Σₜ₌₁^{T}Jₜ.

A batch of b=128 word pairs can be processed at a time during minimization. Word vectors are updated iteratively with stochastic gradient descent and a learning rate of lr=1.0. At the end of the minimization the average loss may be approximately 2.02 and the resulting embedding can be illustrated in FIG. 4A by means of a t-SNE projection. The hyper-parameters in the model can be tuned by trial and error.

FIG. 4A illustrates an example word cloud 400 generated from drilling reports (e.g., 200 and/or 202). The vectors learned in this stage can be clustered into clusters 422 of concepts or semantic relationships. For example, vectors can be clustered into clusters 422 of concepts such as integers 402, operations 404, well diameters 406, pump actions 408, remarks 410, well trajectories 412, months 414, years 416, issues and 418. Moreover, the vectors can include labels 420, which can be based on the corresponding words.

To illustrate, clusters 422 representing words such as “incident”, “accident”, “issues”, and “environmental” may appear together in a cluster of issues 418. The issues 418 in this example can be a concept shared by such words (e.g., semantic relationship between the word vectors). Clusters 422 can also be formed according to specific patterns. For example, a cluster of integers 402 can include integers grouped in ascending order.

The word embedding can be robust to noise. For example, concepts or words remarks and remark in the remarks 410 cluster can be arranged or depicted in close proximity based on their similarity or relevance to each other. Abbreviations can also be captured, such as in “circulate” and “circ”. These properties can be used for overcoming nuances of technical languages which may be common in drilling reports (e.g., 200 and 202).

In order to classify sentences in drilling reports, three different neural network architectures may be tested: simple network with arithmetic averaging, convolutional neural network (CNN) and long short-term memory network (LSTM).

FIG. 4B illustrates a diagram of an example interactive word cloud 450 generated from drilling reports. The word cloud 450 can group, arrange, or cluster word vectors based on concepts or semantic relationships. Relationships, clusters, and/or groupings can be depicted graphically. For examples, word vectors having related concepts can be clustered together and colored based on their related concepts. Clusters and/or concepts can be interactive as well.

For example, a cluster of words associated with the concept integers 454 can be selected 452 by a user. The selection 452 can trigger a search and/or presentation of reports 456 associated with the concept integers 454 selected. This may allow a user to identify and select a specific cluster or concept of interest and obtain drilling reports related to the selected cluster or concept. Users can thus quickly navigate and filter through reports in a visual and interacted manner.

The selection 452 can also result in the word cloud 450 maximizing or focusing on the selected cluster or concept. The maximized or focused cluster or concept can depict sub-clusters based on sub-concepts, which can also be selectable. This can allow a user to navigate and drill down into more granular concepts or clusters.

FIG. 5 illustrates a diagram of an example dendrogram 500 of concepts of drilling reports. The dendrogram 500 can provide a hierarchical visualization of concepts from the drilling reports. The various levels 504-558 (by even numbers) can represent different concepts in the dendrogram 500, which can be arranged in a hierarchical manner. The words 502 can be depicted in the dendrogram 500 and arranged by proximate location to the levels 504-558.

The dendrogram 500 can be interactive. Thus, a user can select a specific level to obtain reports associated with the selected level. The user can navigate the various levels 504-558 for a specific concept depending on the desired granularity.

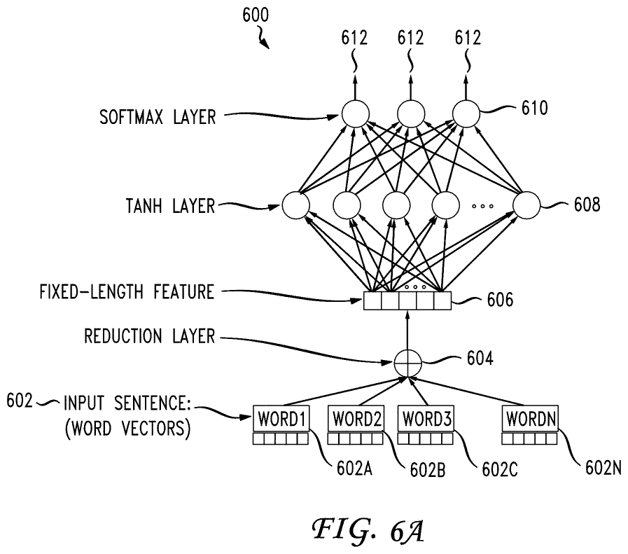

FIGS. 6A through 6D illustrate example neural networks for classifying sentences in drilling reports. With reference to FIG. 6A, a simple network with arithmetic averaging 600 can receive word vectors 602A-N (collectively 602) for an input sentence 602 and process the input sentence 602 through a reduction layer 604. Fixed-length features 606 can be assigned to sentences by averaging, via the reduction layer 604, their constituent word vectors. The features 606 can then be passed to a fully connected hidden layer 608 with 20 tanh neurons, followed by a softmax classification layer 610 to generate outputs 612, which can include classifications. Words that are not present in the vocabulary can be assigned a zero vector.

FIG. 6B illustrates a convolutional neural network 620. Here, input sentence 602 can be padded to have at least the maximum sentence length in all drilling reports. The padding can include introducing a special padding token not present in the corpus. In this architecture, word vectors 602A-N can be passed to an embedding layer, which can convert words in the vocabulary into the corresponding word vectors.

Next, a convolution layer, which can include filters 628 and features 630, and a max pooling layer 632 can be interleaved twice in a total of four additional layers. The two convolutional layers 626 can include 128 filters of length 3 and the two max pooling layers 632 can halve their inputs. The architecture can further include a fully connected layer 634 composed of 128 ReLU neurons and a fully connected softmax layer 636.

FIG. 6C illustrates a long short-term memory network 640. This example can begin with an embedding layer 642 on input sentence including word vectors 602B-M. A long short-term memory layer 644 with 100 neurons can be appended, followed by a dropout layer 646, which can be a 0.5 dropout. The architecture can further include a fully connected softmax layer 648.

FIG. 6D illustrates an example neural network classification 650. First, an input sentence 602 of word vectors 652A-D can be processed by a reduction operation 654 and processed through a hidden layer 656. The result can then be processed via a softmax layer 658 to generate a predicted label 660 for the input sentence 652. The predicted label 660 can be tested to confirm results comparable to an expert prediction 662.

Referring to the neural networks illustrated in FIGS. 6A through 6D, the neural networks can be trained on a set of labeled sentences provided by a drilling user or expert. These sentences can be extracted from PT drilling reports 200 and/or NPT drilling reports 202. Each labeled sentence can be preprocessed with the same regular expressions used for cleaning the corpus. A portion can be used for training and another portion can be saved for testing.

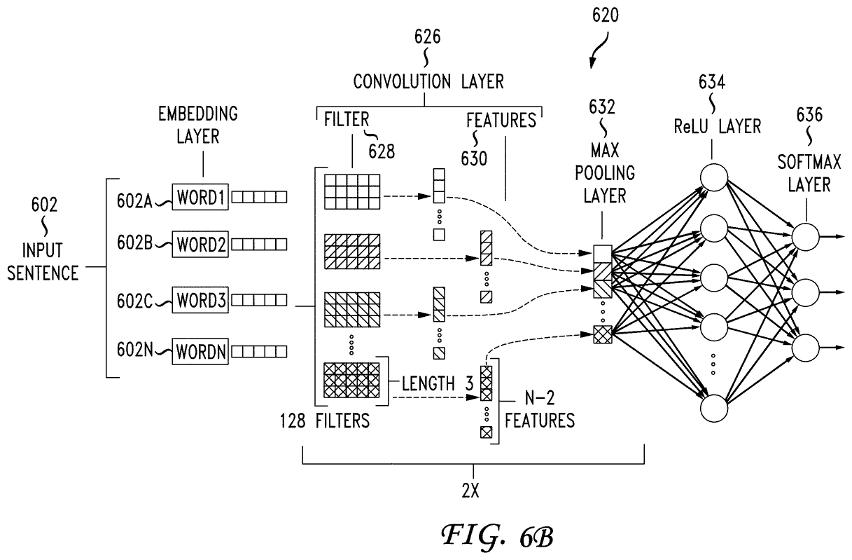

FIG. 7 illustrates a diagram of an example word cloud 700 from drilling reports. As illustrated, the word cloud 700 shows an example of the frequency of physical units, acronyms, and abbreviations that are often included in drilling reports. These features can further complicate sentence classification as previously noted. Moreover, certain words, such as “incident” and “accident” may be frequently reported. For example, the word cloud 700 can include a cluster 720 of repeated and/or related words such as “incident” and “accident”.

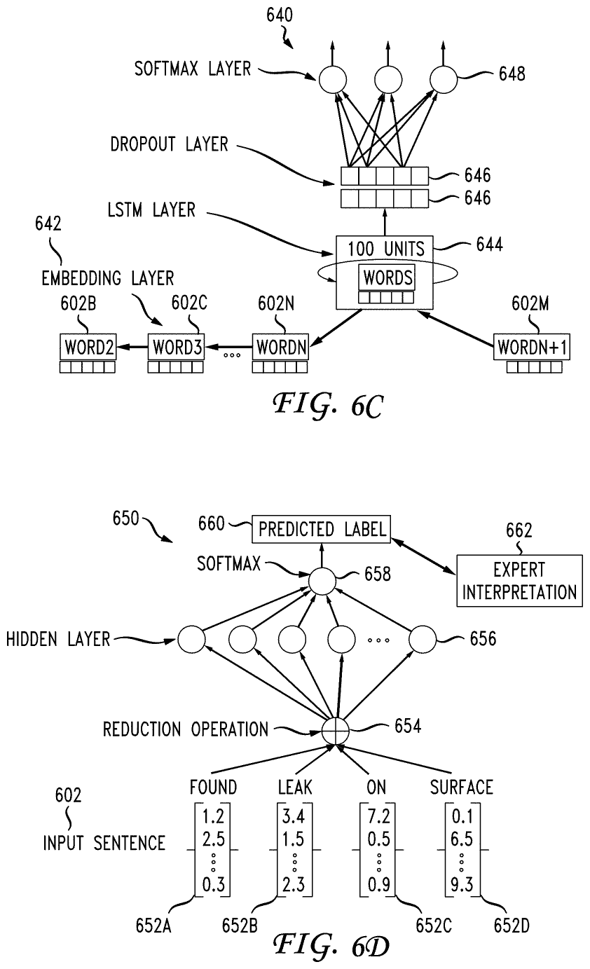

FIG. 8 illustrates a plot 800 of report sentence lengths. The plot 800 includes the frequency 804 of the numbers of words 802 in a drilling report. As illustrated, the plot 800 can be a histogram plot. Compared to non-technical written English, the dataset from this plot includes significantly shorter and incomplete sentences. This can create a challenge in the natural learning process.

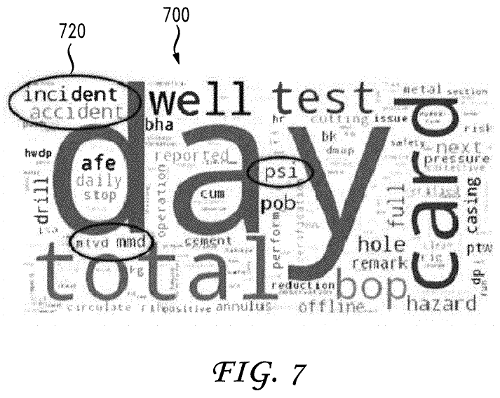

However, drilling reports may contain high repetition of n-grams. For example, FIG. 9 illustrates a graph 900 depicting the frequency of 3-grams and a graph 906 depicting the frequency of 4-grams from drilling reports. The graph 900 includes the frequency 902 of 3-grams and the graph 906 includes the frequency 902 of 4-grams. As illustrated, the drilling reports from this dataset contain a high repetition of sentences.

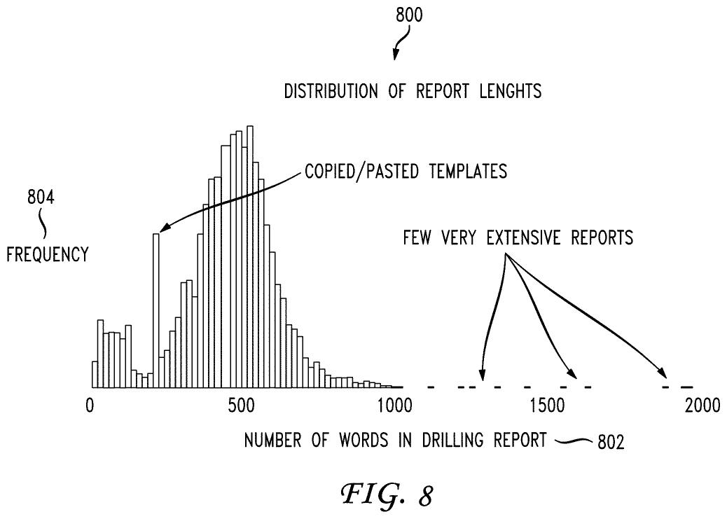

FIG. 10A illustrates an example classification 1000 of sentences. The classification 1000 can be generated through a neural network as previously described. In this example, the sentences can be classified by symptom 1002, action 1004, an event 1006, or a result 1008. For example, sentences in drilling reports can be classified as pertaining to a symptom, an action, an event, or a symptom. Other classifications can also be performed based on the needs or context for the classification 1000. In this example, symptoms, actions, events, and results are provided as non-limiting examples for the sake of explanation and clarity.

The classification of each sentence in the reports can enable an analysis of sequencing behavior. For example, a drilling engineer may be interested in analyzing cases where the symptoms were followed by failure events without any action, or looking up all the actions taken for a specific symptom.

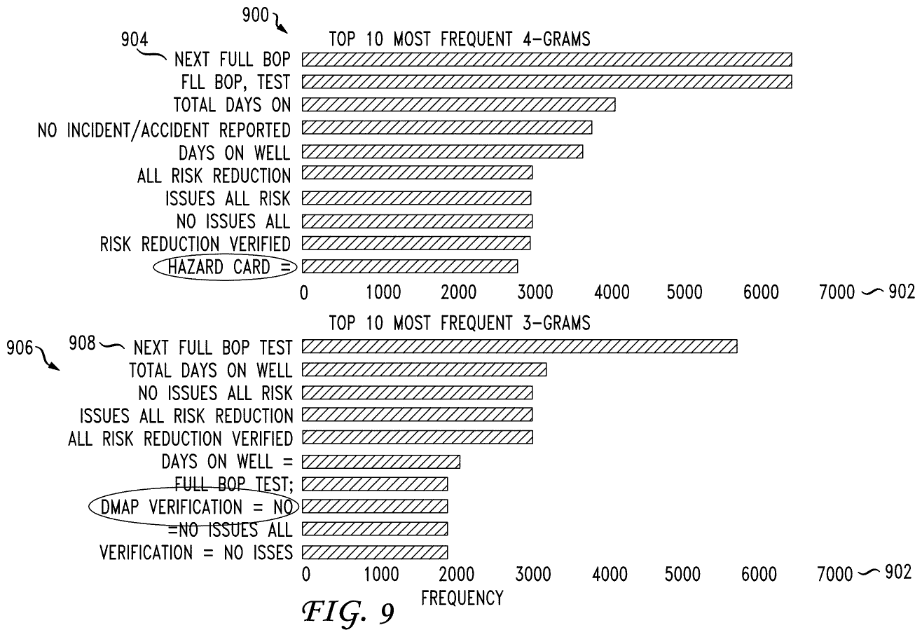

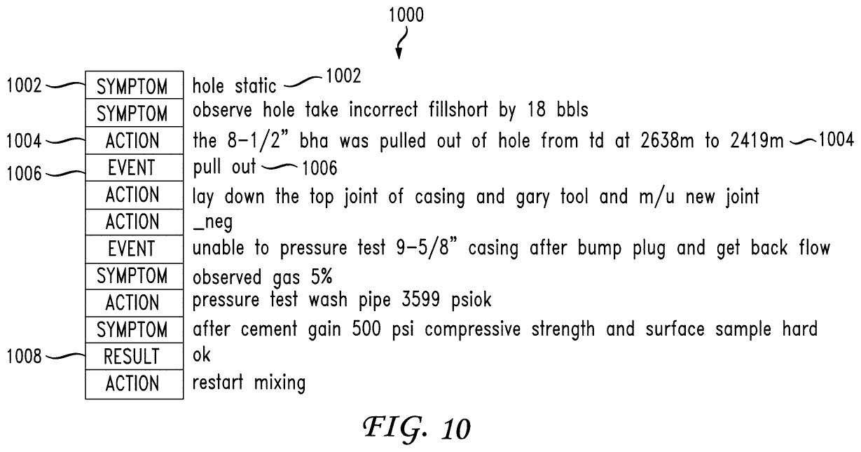

Referring to FIG. 11A, a drilling decision support tool 1120 can allow a user, such as the drilling engineer in our previous example, to automatically retrieve particular sequences obtained based on the classification (e.g., classification 1000) of sentences from a large number of drilling reports. For example, the tool 1120 can identify and retrieve a sequence involving a symptom followed by no action and a particular event or result.

The tool 1120 can include a search portion 1122 where a user can type a string, value, or query to be searched within the drilling reports. In the search portion 1122, the user search for a particular classification, such as symptom 1124. For example, the user can type “Ream down to 3856 m and observe erratic torque” in the search portion 1122 to search drilling reports containing sentences classified as symptom that include the specified search parameter, namely, “Ream down to 3856 m and observe erratic torque”.

The tool 1120 can identify a particular sequence associated with the search, and identify any instances of the particular sequence found in the drilling reports. For example, the tool 1120 can identify a particular sequence of Symptom→Action→Result, and identify instances of that particular sequence within the drilling reports where the symptom 1124 in the sequence is similar to “Ream down to 3856 m and observe erratic torque”, as defined in the search portion 1122.

Based on an example search for the sequence of symptom→Action→Result, where the symptom is “Ream down to 3856 m and observe erratic torque”, the tool 1120 can present the actions 1128 and result 1130, 1132 for that particular search. This way, the user can view or access the actions and result in the drilling reports resulting from the symptom 1124 from the search.

The tool 1120 can depict the actions 1128 and results 1130, 1132 in different ways. For example, actions 1128 can be displayed as text, an image, a code, a summary, etc. Similarly, the results 1130, 1132 can be displayed as text, charts, graphics, percentages or other values, etc. Moreover, the tool 1120 can depict a description 1126 of the search results, as well as other information, such as links, summaries, documents, etc.

The tool 1120 can also allow the user to interact with the actions 1128 and/or results 1130, 1132. For example, the user can select a specific action to retrieve additional information about that action and/or corresponding report(s). As another example, the user can select a result to modify the searched sequence to include results involving the selected result. Moreover, the user can select one or more specific reports from the tool 1120, which can be identified based on the search results. The user can also modify the search string or value in the search portion 1122 and/or the sequence for the search. For example, the user can modify the sequence to include Symptom→Event or Event←Symptom in order to find the events following a particular symptom or the symptom preceding a particular event.

The tool 1120 can be used by a user to support decisions in real-time or during operations. For example, whenever a symptom is observed during a drilling operation, the tool 1120 can display actions that were taken in the past and the results from those actions.

FIG. 11B illustrates another example of a search and recommendation tool that gives success rates for actions taken in the past for a symptom observed in real time. A symptom 1152 can be detected during a drilling operation. The tool can generate a search 1154 based on the detected symptom 1152. Classifications from a database 1156 of drilling reports can be searched to identify and report a sequence 1158 of specific actions 1160 and results 1162 based on the symptom 1152 detected and search 1154. The user can thus quickly view different actions 1160 reported for the particular symptom 1152 and their corresponding results 1162 (e.g., success or failure rate). This can allow the user to quickly identify a course of action after experiencing the symptom 1152.

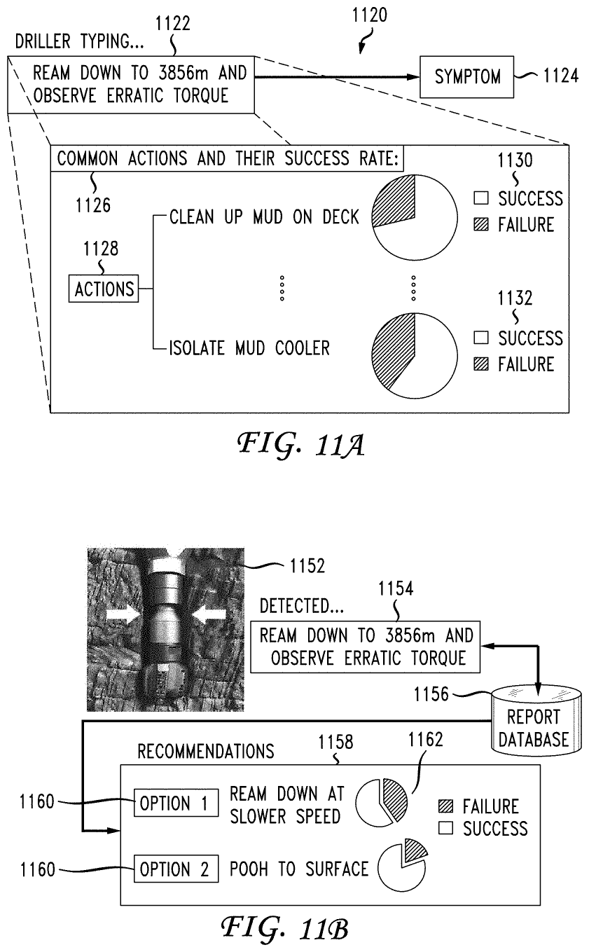

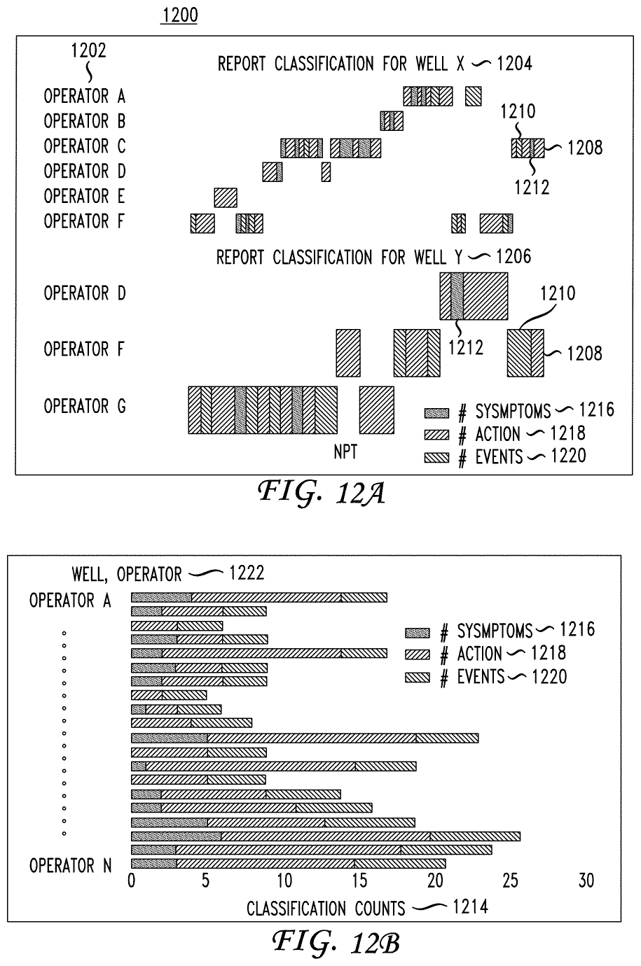

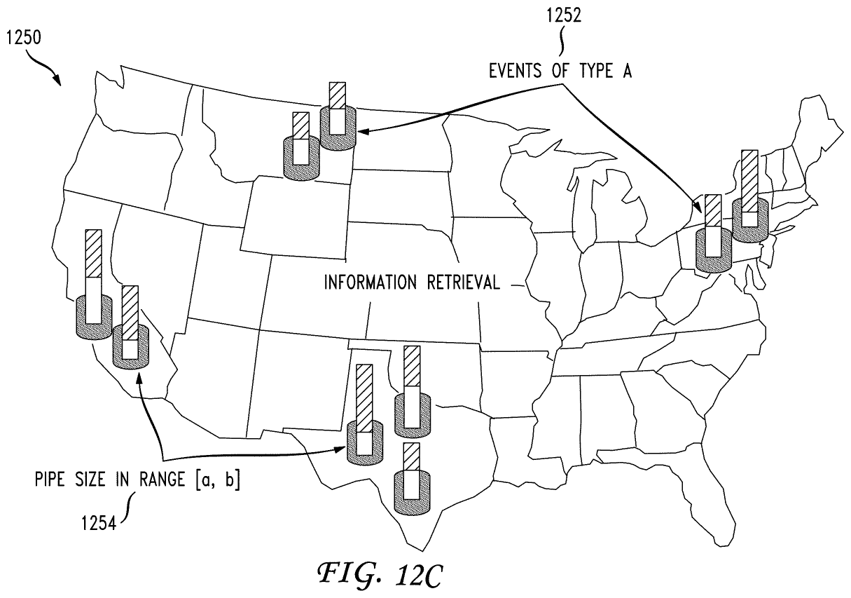

FIG. 12A illustrates a diagram of an example NPT sequencing in reports from different operators 1202 for well 1204 and well 1206. The NPT sequencing can display the sequence of actions 1208, events 1210, and symptoms 1212 for the different operators 1202 for well 1204 and 1206.

FIG. 12B illustrates a chart illustrating selective extraction of wells based on automated classification. The chart can depict the classification counts 1214 of symptoms 1216, actions 1218, and events 1220 for specific well-operator combinations 1222. The chart can identify problematic or over-performing wells or well-operator combinations 1222, and their corresponding classification counts 1214. The chart can also be used for more advanced queries such as retrieving all wells with a specific sequence of Symptom→Action→Result.

FIG. 12C illustrates a Geographic Information System (GIS) plot where the classification of drilling reports is presented. Based on this spatial classification, sales teams can be aware of which equipment is at high demand on a particular region of the country, thus they can adjust their sale strategy. Furthermore, drillers can learn from the types of problems classified by the tool and avoid repeating the same actions that led to failure for that particular field or region.

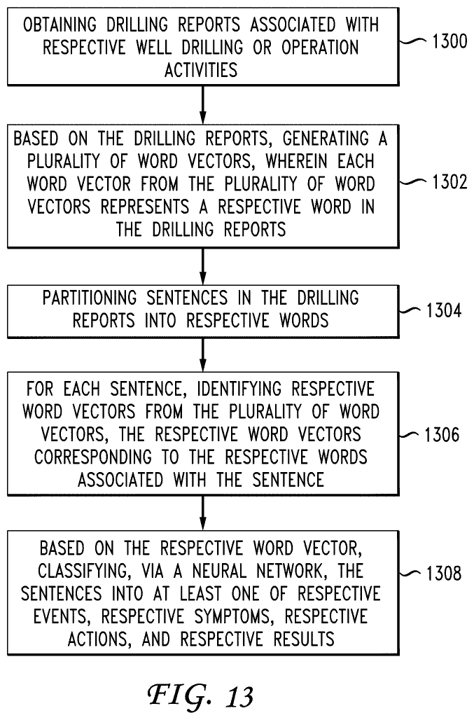

Having disclosed some basic system components and concepts, the disclosure now turns to the example method embodiment shown in FIG. 13. The steps outlined herein are exemplary and can be implemented in any combination thereof, including combinations that exclude, add, or modify certain steps.

At step 1300, the method can involve obtaining drilling reports associated with respective well drilling or operation activities. Based on the drilling reports, at step 1302, the method can involve generating word vectors. Each word vector can represent a respective word in the drilling reports, as previously explained.

In some cases, the drilling reports can be processed through a denoising layer to yield a corpus. The denoising layer can be configured to replace acronyms with corresponding descriptions, remove symbols, replace symbols with regular expressions, change plurals to singular form, and cleanup the text in other ways.

At step 1304, the method can involve partitioning sentences in the drilling reports into respective words. At step 1306, the method can involve, for each sentence, identifying respective word vectors from the word vectors. The respective word vectors can correspond to the respective words associated with the sentence. For example, the word vectors can correspond to the words obtained when the sentence was partitioned into words.

In some cases, step 1304 can involve splitting a corpus processed through a denoising layer into words, and step 1306 can include processing the words through a word-to-vector transformation operation to generate word vectors for the words from the corpus cleaned via the denoising layer.

The word vectors can be used to generate an interactive visualization, such as a word cloud or a dendrogram. For example, the word vectors can be projected into a Cartesian plane and visually presented in an interface, such as a word cloud. Each word or word vector can be labeled. For example word vectors can be labeled based on a respective word corresponding to the word vector in the Cartesian plane. The word vectors can be clustered in the Cartesian plane based on semantic relationships between the respective word represented by the word vectors.

Based on the respective word vectors, at step 1308, the method can involve feeding the vectors for each word in a sentence into a neural network that takes care of combining the word vectors in a non-trivial way. This combination can represent the associated sentences, which are classified into respective events, respective symptoms, respective actions, and/or respective results.

The method can also involve identifying respective sequences based on the classifications. For example, the method can involve identifying sequences of events, symptoms, actions, and/or results. The sequences can be presented via a graphical tool to allow a user to view or access sequences of information based on a filtering criteria, such as a defined sequence and/or one or more search strings for the search.

For example, a user can provide a filtering criteria which defines a particular string or value for an event, symptom, action, and/or result, and a graphical tool can filter respective content and sequences from drilling reports to identify one or more sequences matching the filtering criteria. The filtering criteria can also specify the particular sequence to be searched or identified. Thus, the filtering criteria can not only define a string or value to search for a particular concept, such as an event or symptom, but also a sequence of concepts, such as a symptom followed by an action taken in response to the system, where one or more of the concepts in the sequence of concepts matches the search string or value.

The graphical tool can present the identified sequence(s), including any associated information. For example, based on a search of the symptom A for a sequence of Symptom→Action, the graphical tool can present all of the instances of symptom A found in the drilling reports as well as their corresponding action. The graphical tool can also enable to user to interact with search results, refine search results, access data or reports from the search results, or even reconfigure the display of search results (e.g., graph, list, table, etc.).

Having disclosed example systems and concepts for classification and visualization of drilling reports, the disclosure now turns to FIG. 14, which illustrates an example computing device which can be employed to perform various steps, methods, and techniques disclosed above, such as one or more steps of the method illustrated in FIG. 13. The more appropriate embodiment will be apparent to those of ordinary skill in the art when practicing the present technology. Persons of ordinary skill in the art will also readily appreciate that other system embodiments are possible.

Example system and/or computing device 1400 includes a processing unit (CPU or processor) 1410 and a system bus 1405 that couples various system components including the system memory 1415 such as read only memory (ROM) 1420 and random access memory (RAM) 1425 to the processor 1410. The processors of FIG. 1 (i.e., the downhole processor 44, the local processor 16, and the remote processor 12) can all be forms of this processor 1410. The system 1400 can include a cache 1412 of high-speed memory connected directly with, in close proximity to, or integrated as part of the processor 1410. The system 1400 copies data from the memory 1415 and/or the storage device 1430 to the cache 1412 for quick access by the processor 1410. In this way, the cache provides a performance boost that avoids processor 1410 delays while waiting for data. These and other modules can control or be configured to control the processor 1410 to perform various operations or actions.

Other system memory 1415 may be available for use as well. The memory 1415 can include multiple different types of memory with different performance characteristics. It can be appreciated that the disclosure may operate on a computing device 1400 with more than one processor 1410 or on a group or cluster of computing devices networked together to provide greater processing capability. The processor 1410 can include any general purpose processor and a hardware module or software module, such as module 1 1432, module 2 1434, and module 3 1436 stored in storage device 1430, configured to control the processor 1410 as well as a special-purpose processor where software instructions are incorporated into the processor. The processor 1410 may be a self-contained computing system, containing multiple cores or processors, a bus, memory controller, cache, etc. A multi-core processor may be symmetric or asymmetric. The processor 1410 can include multiple processors, such as a system having multiple, physically separate processors in different sockets, or a system having multiple processor cores on a single physical chip. Similarly, the processor 1410 can include multiple distributed processors located in multiple separate computing devices, but working together such as via a communications network. Multiple processors or processor cores can share resources such as memory 1415 or the cache 1412, or can operate using independent resources. The processor 1410 can include one or more of a state machine, an application specific integrated circuit (ASIC), or a programmable gate array (PGA) including a field PGA.

The system bus 1405 may be any of several types of bus structures including a memory bus or memory controller, a peripheral bus, and a local bus using any of a variety of bus architectures. A basic input/output (BIOS) stored in ROM 1420 or the like, may provide the basic routine that helps to transfer information between elements within the computing device 1400, such as during start-up. The computing device 1400 further includes storage devices 1430 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 1430 can include software modules 1432, 1434, 1436 for controlling the processor 1410. The system 1400 can include other hardware or software modules. The storage device 1430 is connected to the system bus 1405 by a drive interface. The drives and the associated computer-readable storage devices provide nonvolatile storage of computer-readable instructions, data structures, program modules and other data for the computing device 1400.

In one aspect, a hardware module that performs a particular function includes the software component stored in a tangible computer-readable storage device in connection with the necessary hardware components, such as the processor 1410, bus 1405, display or output device 1435, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 1400 is a small, handheld computing device, a desktop computer, or a computer server. When the processor 1410 executes instructions to perform “operations”, the processor 1410 can perform the operations directly and/or facilitate, direct, or cooperate with another device or component to perform the operations.

Although the exemplary embodiment(s) described herein employs the hard disk 1430, other types of computer-readable storage devices which can store data that are accessible by a computer, such as magnetic cassettes, flash memory cards, digital versatile disks (DVDs), cartridges, random access memories (RAMs) 1425, read only memory (ROM) 1420, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1400, an input device 1445 represents any number of input mechanisms, such as a microphone for speech, a touch-sensitive screen for gesture or graphical input, keyboard, mouse, motion input, speech and so forth. An output device 1435 can also be one or more of a number of output mechanisms known to those of skill in the art. In some instances, multimodal systems enable a user to provide multiple types of input to communicate with the computing device 1400. The communications interface 1440 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 1410. The functions these blocks represent may be provided through the use of either shared or dedicated hardware, including, but not limited to, hardware capable of executing software and hardware, such as a processor 1410, that is purpose-built to operate as an equivalent to software executing on a general purpose processor. For example the functions of one or more processors presented in FIG. 14 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1420 for storing software performing the operations described below, and random access memory (RAM) 1425 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1400 shown in FIG. 14 can practice all or part of the recited methods, can be a part of the recited systems, and/or can operate according to instructions in the recited tangible computer-readable storage devices. Such logical operations can be implemented as modules configured to control the processor 1410 to perform particular functions according to the programming of the module. For example, FIG. 14 illustrates three modules Mod1 1432, Mod2 1434 and Mod3 1436 which are modules configured to control the processor 1410. These modules may be stored on the storage device 1430 and loaded into RAM 1425 or memory 1415 at runtime or may be stored in other computer-readable memory locations.

One or more parts of the example computing device 1400, up to and including the entire computing device 1400, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 1410 can include all types of processors disclosed herein, including a virtual processor. However, when referring to a virtual processor, the processor 1410 includes the software components associated with executing the virtual processor in a virtualization layer and underlying hardware necessary to execute the virtualization layer. The system 1400 can include a physical or virtual processor 1410 that receive instructions stored in a computer-readable storage device, which cause the processor 1410 to perform certain operations. When referring to a virtual processor 1410, the system also includes the underlying physical hardware executing the virtual processor 1410.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of, the surrounding wellbore even though the wellbore or portions of it may be deviated or horizontal.

Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicate that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Statements of the disclosure include:

Statement 1: A method comprising obtaining drilling reports associated with respective well drilling or operation activities; based on the drilling reports, generating a plurality of word vectors, wherein each word vector from the plurality of word vectors represents a respective word in the drilling reports; partitioning sentences in the drilling reports into respective words; for each sentence, identifying respective word vectors from the plurality of word vectors, the respective word vectors corresponding to the respective words associated with the sentence; based on the respective word vectors, classifying, via a neural network, the sentences into at least one of respective events, respective symptoms, respective actions, respective results, and a different category of labels.

Statement 2: A method according to Statement 1, wherein the drilling reports comprise reports generated during at least one of non-productive time periods and productive time periods in the respective well drilling or operation activities, the non-productive time periods being associated with a troubleshooting event corresponding to at least one of a failure, an error, a problem, and a disruption, and the productive time periods comprising periods of time when drilling operations are being performed.

Statement 3: A method according to any of Statements 1 and 2, further comprising projecting the plurality of word vectors into a cartesian plane; and labeling each word vector in the cartesian plane based on a respective word corresponding to the word vector in the cartesian plane.

Statement 4: A method according to any of Statements 1 through 3, further comprising: clustering the plurality of word vectors in the cartesian plane based on semantic relationships between the respective word represented by each word vector, to yield semantic clusters.

Statement 5: A method according to any of Statements 1 through 4, further comprising: generating, based on the semantic clusters, a graphical word cloud with semantic relationships that is navigable with different levels of granularity selected in a corresponding dendrogram.

Statement 6: A method according to any of Statements 1 through 5, further comprising: presenting the graphical word cloud on a display, wherein at least one of semantic clusters of words in the graphical word cloud and the words associated with the semantic clusters of words are user-selectable via a computing device associated with the display, wherein user selection of the at least one of semantic clusters of words in the graphical word cloud and the words associated with the semantic clusters of words triggers a presentation of one or more respective reports associated with the at least one of semantic clusters of words in the graphical word cloud and the words associated with the semantic clusters of words.

Statement 7: A method according to any of Statements 1 through 6, further comprising: based on the classifying of the sentences and filtering criteria defining a particular event, a particular symptom, a particular action, or a particular result, filtering the respective sequences to identify one or more sequences in drilling reports matching the filtering criteria; and presenting the identified one or more sequences matching the filtering criteria, the one or more sequences comprising at least one of the particular event, the particular symptom, the particular action, and the particular result.

Statement 8: A method according to any of Statements 1 through 7, further comprising: spatial location information extracted, plotting on a Geographic Information System (GIS) the classification of sentences into respective events, respective symptoms, respective actions, and respective results.

Statement 9: A system comprising: one or more processors; and at least one computer-readable storage medium having stored therein instructions which, when executed by the one or more processors, cause the one or more processors to: obtain a plurality of drilling reports associated with respective well drilling or operation activities; based on a word-to-vector transformation operation on the plurality of drilling reports, generate a plurality of word vectors, wherein each word vector from the plurality of word vectors represents a respective word in the plurality of drilling reports; partition sentences in the plurality of drilling reports into respective words; for each sentence, identifying respective word vectors from the plurality of word vectors, the respective word vectors corresponding to the respective words associated with the sentence; based on the respective word vectors, classify via a neural network, the sentences into at least one of respective events, respective symptoms, respective actions, respective results, and a different category of labels.

Statement 10: A system according to Statements 9, the at least one computer-readable storage medium storing additional instructions which, when executed by the one or more processors, cause the one or more processors to: project the plurality of word vectors into a cartesian plane; and label each word vector in the cartesian plane based on a respective word corresponding to the word vector in the cartesian plane.

Statement 11: A system according to any of Statements 9 and 10, the at least one computer-readable storage medium storing additional instructions which, when executed by the one or more processors, cause the one or more processors to: cluster the plurality of word vectors in the cartesian plane based on semantic relationships between the respective word represented by each word vector, to yield semantic clusters.

Statement 12: A system according to any of Statements 9 through 11, the at least one computer-readable storage medium storing additional instructions which, when executed by the one or more processors, cause the one or more processors to: generate, based on the semantic clusters, a graphical word cloud with semantic relationships.

Statement 13: A system according to any of Statements 9 through 12, the at least one computer-readable storage medium storing additional instructions which, when executed by the one or more processors, cause the one or more processors to: present the graphical word cloud on a display, wherein at least one of semantic clusters of words in the graphical word cloud and the words associated with the semantic clusters of words are user-selectable via a computing device associated with the display, wherein user selection of the at least one of semantic clusters of words in the graphical word cloud and the words associated with the semantic clusters of words triggers a presentation of one or more respective reports associated with the at least one of semantic clusters of words in the graphical word cloud and the words associated with the semantic clusters of words.

Statement 14: A system according to any of Statements 9 through 13, the at least one computer-readable storage medium storing additional instructions which, when executed by the one or more processors, cause the one or more processors to: based on the classifying of the sentences and on filtering criteria defining a particular event, a particular symptom, a particular action, or a particular result, filter the respective sequences to identify one or more sequences matching the filtering criteria; and present the identified one or more sequences matching the filtering criteria, the one or more sequences comprising at least one of the particular event, the particular symptom, the particular action, and the particular result.

Statement 15: A system according to any of Statements 9 through 14, the at least one computer-readable storage medium storing additional instructions which, when executed by the one or more processors, cause the one or more processors to: based on the classifying of the sentences into at least one of respective events, respective symptoms, respective actions, and respective results, as well as extraction of spatial location information, plotting on a Geographic Information System (GIS) the classification of sentences into respective events, respective symptoms, respective actions, and respective results.

Statement 16: A non-transitory computer-readable storage medium comprising: instructions stored on the non-transitory computer-readable storage medium, the instructions, when executed by at least one processor, cause the at least one processor to: obtain a plurality of drilling reports associated with respective well drilling or operation activities; based on a word-to-vector transformation operation on the plurality of drilling reports, generate a plurality of word vectors, wherein each word vector from the plurality of word vectors represents a respective word in the plurality of drilling reports; partition sentences in the plurality of drilling reports into respective words; for each sentence, identifying respective word vectors from the plurality of word vectors, the respective word vectors corresponding to the respective words associated with the sentence; based on the respective word vectors, classify via a neural network, the sentences into at least one of respective events, respective symptoms, respective actions, respective results, and a different category of labels.

Statement 17: A non-transitory computer-readable storage medium according to Statement 16, storing additional instructions which, when executed by the at least one processor, cause the at least one processor to: based on the classifying of the sentences into at least one of respective events, respective symptoms, respective actions, and respective results, determine respective sequences of at least two of specific events, specific symptoms, specific actions, and specific results; based on filtering criteria defining a particular event, a particular symptom, a particular action, or a particular result, filter the respective sequences to identify one or more sequences matching the filtering criteria; and present the identified one or more sequences matching the filtering criteria, the one or more sequences comprising at least one of the particular event, the particular symptom, the particular action, and the particular result.

Statement 18: A non-transitory computer-readable storage medium according to any of Statements 16 and 17, storing additional instructions which, when executed by the at least one processor, cause the at least one processor to: based on the classifying of the sentences into at least one of respective events, respective symptoms, respective actions, and respective results, as well as extraction of spatial location information, plotting on a Geographic Information System (GIS) the classification of sentences into respective events, respective symptoms, respective actions, and respective results.

Statement 19: A non-transitory computer-readable storage medium according to any of Statements 16 through 18, storing additional instructions which, when executed by the one or more processors, cause the one or more processors to: process the drilling reports through a denoising layer to yield a corpus, the denoising layer being configured to perform at least one of replace acronyms with corresponding descriptions, remove symbols, replace symbols with regular expressions, and change plurals to singular form.

Statement 20: A non-transitory computer-readable storage medium storing instructions which, when executed by one or more processors, cause the one or more processors to perform a method according to any of Statements 1 through 18.

Statement 21: A method comprising: generating interactive plots for exploration of concepts in drilling reports; receiving one or more queries based on classified sentences from the drilling reports, the one or more queries including queries of wells that present a particular sequence of symptoms, actions, and results; and generating a Geographic Information System (GIS) plot which presents classifications with spatial coordinates.

Statement 22: A system comprising means for performing a method according to any of Statements 1 through 8.

What is claimed is:

1. A method comprising:
obtaining drilling reports associated with respective well drilling or operation activities;
based on the drilling reports, generating a plurality of word vectors, wherein each word vector from the plurality of word vectors represents a respective word in the drilling reports;
partitioning sentences in the drilling reports into respective words;
for each sentence, identifying respective word vectors from the plurality of word vectors, the respective word vectors corresponding to the respective words associated with the sentence; and
based on the respective word vectors, classifying, via a neural network, the sentences into at least one of respective events, respective symptoms, respective actions, respective results, and a different category of labels.

2. The method of claim 1, wherein the drilling reports comprise reports generated during at least one of non-productive time periods and productive time periods in the respective well drilling or operation activities, the non-productive time periods being associated with a troubleshooting event corresponding to at least one of a failure, an error, a problem, and a disruption, and the productive time periods comprising periods of time when drilling operations are being performed.

3. The method of claim 1, further comprising:
projecting the plurality of word vectors into a cartesian plane; and
labeling each word vector in the cartesian plane based on a respective word corresponding to the word vector in the cartesian plane.

4. The method of claim 3, further comprising:
clustering the plurality of word vectors in the cartesian plane based on semantic relationships between the respective word represented by each word vector, to yield semantic clusters.

5. The method of claim 4, further comprising:
generating, based on the semantic clusters, a graphical word cloud with semantic relationships that is navigable with different levels of granularity selected in a corresponding dendrogram.

6. The method of claim 5, further comprising:
presenting the graphical word cloud on a display, wherein at least one of semantic clusters of words in the graphical word cloud and the words associated with the semantic clusters of words are user-selectable via a computing device associated with the display,
wherein user selection of the at least one of semantic clusters of words in the graphical word cloud and the words associated with the semantic clusters of words triggers a presentation of one or more respective reports associated with the at least one of semantic clusters of words in the graphical word cloud and the words associated with the semantic clusters of words.

7. The method of claim 1, further comprising:
based on the classifying of the sentences and filtering criteria defining a particular event, a particular symptom, a particular action, or a particular result, filtering the respective sequences to identify one or more sequences in drilling reports matching the filtering criteria; and
presenting the identified one or more sequences matching the filtering criteria, the one or more sequences comprising at least one of the particular event, the particular symptom, the particular action, and the particular result.

8. The method of claim 1, further comprising:
spatial location information extracted, plotting on a Geographic Information System (GIS) the classification of sentences into respective events, respective symptoms, respective actions, and respective results.

9. A system comprising:
one or more processors; and
at least one computer-readable storage medium having stored therein instructions which, when executed by the one or more processors, cause the one or more processors to:
obtain a plurality of drilling reports associated with respective well drilling or operation activities;
based on a word-to-vector transformation operation on the plurality of drilling reports, generate a plurality of word vectors, wherein each word vector from the plurality of word vectors represents a respective word in the plurality of drilling reports;
partition sentences in the plurality of drilling reports into respective words;
for each sentence, identifying respective word vectors from the plurality of word vectors, the respective word vectors corresponding to the respective words associated with the sentence; and
based on the respective word vectors, classify via a neural network, the sentences into at least one of respective events, respective symptoms, respective actions, respective results, and a different category of labels.

10. The system of claim 9, the at least one computer-readable storage medium storing additional instructions which, when executed by the one or more processors, cause the one or more processors to:
project the plurality of word vectors into a cartesian plane; and
label each word vector in the cartesian plane based on a respective word corresponding to the word vector in the cartesian plane.

11. The system of claim 10, the at least one computer-readable storage medium storing additional instructions which, when executed by the one or more processors, cause the one or more processors to:
cluster the plurality of word vectors in the cartesian plane based on semantic relationships between the respective word represented by each word vector, to yield semantic clusters.

12. The system of claim 11, the at least one computer-readable storage medium storing additional instructions which, when executed by the one or more processors, cause the one or more processors to:
generate, based on the semantic clusters, a graphical word cloud with semantic relationships.

13. The system of claim 12, the at least one computer-readable storage medium storing additional instructions which, when executed by the one or more processors, cause the one or more processors to:
present the graphical word cloud on a display, wherein at least one of semantic clusters of words in the graphical word cloud and the words associated with the semantic clusters of words are user-selectable via a computing device associated with the display, wherein user selection of the at least one of semantic clusters of words in the graphical word cloud and the words associated with the semantic clusters of words triggers a presentation of one or more respective reports associated with the at least one of semantic clusters of words in the graphical word cloud and the words associated with the semantic clusters of words.

14. The system of claim 13, the at least one computer-readable storage medium storing additional instructions which, when executed by the one or more processors, cause the one or more processors to:
based on the classifying of the sentences and on filtering criteria defining a particular event, a particular symptom, a particular action, or a particular result, filter the respective sequences to identify one or more sequences matching the filtering criteria; and
present the identified one or more sequences matching the filtering criteria, the one or more sequences comprising at least one of the particular event, the particular symptom, the particular action, and the particular result.

15. The system of claim 13, the at least one computer-readable storage medium storing additional instructions which, when executed by the one or more processors, cause the one or more processors to:
based on the classifying of the sentences into at least one of respective events, respective symptoms, respective actions, and respective results, as well as extraction of spatial location information, plotting on a Geographic Information System (GIS) the classification of sentences into respective events, respective symptoms, respective actions, and respective results.

16. A non-transitory computer-readable storage medium comprising:
instructions stored on the non-transitory computer-readable storage medium, the instructions, when executed by at least one processor, cause the at least one processor to:
obtain a plurality of drilling reports associated with respective well drilling or operation activities;
based on a word-to-vector transformation operation on the plurality of drilling reports, generate a plurality of word vectors, wherein each word vector from the plurality of word vectors represents a respective word in the plurality of drilling reports;
partition sentences in the plurality of drilling reports into respective words;
for each sentence, identifying respective word vectors from the plurality of word vectors, the respective word vectors corresponding to the respective words associated with the sentence; and
based on the respective word vectors, classify via a neural network, the sentences into at least one of respective events, respective symptoms, respective actions, respective results, and a different category of labels.

17. The non-transitory computer-readable storage medium of claim 16, storing additional instructions which, when executed by the at least one processor, cause the at least one processor to:
based on the classifying of the sentences into at least one of respective events, respective symptoms, respective actions, and respective results, determine respective sequences of at least two of specific events, specific symptoms, specific actions, and specific results;
based on filtering criteria defining a particular event, a particular symptom, a particular action, or a particular result, filter the respective sequences to identify one or more sequences matching the filtering criteria; and
present the identified one or more sequences matching the filtering criteria, the one or more sequences comprising at least one of the particular event, the particular symptom, the particular action, and the particular result.

18. The non-transitory computer-readable storage medium of claim 16, storing additional instructions which, when executed by the at least one processor, cause the at least one processor to:
based on the classifying of the sentences into at least one of respective events, respective symptoms, respective actions, and respective results, as well as extraction of spatial location information, plotting on a Geographic Information System (GIS) the classification of sentences into respective events, respective symptoms, respective actions, and respective results.

19. The non-transitory computer-readable storage medium of claim 16, storing additional instructions which, when executed by the one or more processors, cause the one or more processors to:
process the drilling reports through a denoising layer to yield a corpus, the denoising layer being configured to perform at least one of replace acronyms with corresponding descriptions, remove symbols, replace symbols with regular expressions, and change plurals to singular form.

20. A method comprising:
generating interactive plots for exploration of concepts in drilling reports;
receiving one or more queries based on classified sentences from the drilling reports, the one or more queries including queries of wells that present a particular sequence of symptoms, actions, and results; and
generating a Geographic Information System (GIS) plot which presents classifications with spatial coordinates.
